(19) United States
(12) Patent Application Publication
(10) Pub. No.: US 2008/0109446 A1
(43) Pub. Date: May 8, 2008

(54) Peer-to-peer file download system for IMS network

(76) Inventor: Matrix Xin Wang, QingDao (CN)

Correspondence Address: MCCORMICK, PAULDING & HUBER LLP, 185 ASYLUM STREET, CITY PLACE II, HARTFORD, CT, 06103, US

(21) Appl. No.: 11/717,394

(22) Filed: Mar. 13, 2007

(30) Foreign Application Priority Data
Nov. 7, 2006 (CN) 200610143983.X

(51) Int. Cl. G06F 17/30

(52) U.S. Cl. 707/10; 707/E17.032

(57) ABSTRACT

A server application is interconnected with a number of client/peer terminals, as part of an IMS network. For peer-to-peer transfer of a selected data file, a client terminal establishes and accesses a secure account on the server application. From the server application, the client terminal obtains the network locations of one or more peer terminals having sections/pieces of the data file stored thereon. The client terminal contacts the peer terminals for obtaining the data file sections there from over the IMS network. The client terminal and/or peer terminals transmit accounting data to the server application through secure accounts. The accounting data relates to the amount of data transferred and/or to the data transfer rate, and may be used for billing purposes.

This application is entitled to the benefit of and claims foreign priority under 35 U.S.C. § 119 from Chinese Patent Application No. 200610143983.X, filed Nov. 7, 2006, the disclosure of which is hereby incorporated by reference.

### FIELD OF THE INVENTION

The present invention relates to communications and, more particularly, to file transfer services in an IMS-based network or other communication network.

### BACKGROUND OF THE INVENTION

The IP Multimedia Subsystem (“IMS”) is a standardized “next generation” networking architecture for providing multimedia services in mobile/wireless and fixed/wire-line communication networks. The IMS uses the Internet protocol (IP) for packet-data communications generally, and voice over IP (VoIP) for voice communications, based on a 3GPP/3GPP2 standardized implementation of SIP (session initiation protocol). (SIP is a signaling protocol used for establishing sessions, such as a two-way telephone call or multi-party phone conference, in an IP network.) The IMS works with any packet switched network, both wire-line based and wireless, such as GPRS, UMTS, CDMA2000, and WiMAX. Legacy circuit-switched phone systems and similar networks (e.g., POTS, GSM) are supported through gateways. The IMS includes session control, connection control, and an application services framework along with subscriber and services data. It enables the use of new converged voice and data services, while facilitating the interoperability of these converged services between subscribers.

An IMS-based network 10 is shown in simplified form in FIG. 1. The IMS control architecture includes a home subscriber server (“HSS”) 12 and a call session control function (“CSCF”) 14, and may generally be divided into a services/application layer 16a, an IMS layer 16b, and a transport layer 16c. The HSS 12 is the central repository of all subscriber-specific authorizations and service profiles and preferences. The HSS 12 integrates several functions/elements, some of which may exist already (for example, in the home location register of wireless networks), including subscriber/user profile database, subscriber service permissions, authentication and authorization, subscriber preference settings, mobile authentication server, and the like. An SLF 18 (subscriber location function) is needed when multiple HSS's are used. The CSCF 14 carries out the primary SIP signaling functions in the network. The CSCF 14 includes several types of SIP servers, including a proxy-CSCF server (the first point of contact for device and controls authentication), an interrogating-CSCF server (the entry point of all SIP messages), and a serving-CSCF server, which manages session control functions. Additionally, application servers 20 host and execute services, and interface with the CSCF 14 using SIP. This allows third party providers to easily integrate and deploy their value added services on the IMS infrastructure. Examples of services include caller ID related services, call waiting, call holding, push to talk, conference call servers, voicemail, instant messaging, call blocking, and call forwarding. A circuit-switched (“CS”) network gateway 22 interfaces the IMS 10 with circuit-switched networks 24 such as a public switched telephone network (“PSTN”). The gateway 22 may include a BGCF (breakout gateway control function), which is an SIP server that includes routing functionality based on telephone numbers, an SGW (signaling gateway) that interfaces with the signaling plane of the network 24, an MGCF (media gateway controller function) for call control protocol conversion, and an MGW (media gateway) that interfaces with the media plane of the circuit-switched network 24. An MRF 26 (media resource function) may be provided as a media source in the network, e.g., for multimedia conferencing, text-to-speech conversation and speech recognition, and real-time transcoding of multimedia data, e.g., conversion between different codecs.

At the transport layer 16c, the IMS layer 16b is connected to a core broadband IP network 28, possibly through the MRF 26 and/or an IMS gateway 30. The IMS gateway 30 may include an IMS application layer gateway 32 (“IMS-ALG”) and a translation gateway 34 (“TrGW”) for facilitating communications with networks using different versions of the Internet protocol, e.g., IPv4 and IPv6. The core IP network 28 is also connected to one or more external IP packet data networks 36 (“IP PDN”), e.g., the Internet, and to other networks such as a DSL or other wire-line network 38, wireless local area networks (“WLAN”) 40, and wireless networks 42. Typically, one or more intermediate network elements are used for facilitating these connections, such as a WLAN access gateway (“WAG”) and/or WLAN packet data gateway (“PDG”) 44, a serving GPRS support node (“SGSN”) 46 and gateway GPRS service node (“GGSN”) 48, and a digital subscriber line access multiplexer (“DSLAM”) and broadband access server (“BAS”) 50. The SGSN 46 is responsible for mobility management and IP packet session management. It routes user packet traffic from the radio network 42 to the appropriate GGSN 48, providing access to external packet data networks, in this case the core network 28. The DSLAM 50 is a network device, usually located at a telephone company central office, or within a neighborhood serving area interface as part of a digital loop carrier, that receives signals from multiple customer DSL connections and aggregates the signals on a high-speed backbone line using multiplexing techniques. In this case, the DSLAM 50 connects the DSL network 38 with the core IP network 28.

The networks 38, 40, 42 may be functionally/logically connected to the CSCF 14 through various control/functional elements. For example, the IMS system may include a policy decision function (“PDF”) 52, which enables the access network to be managed using dynamic policies. Additional functional elements 54 (grouped together for simplicity of illustration) may include a service policy decision function (“SPDF”), an access-resource and admission control function (“A-RACF”), and a network attachment subsystem (“NASS”). The SPDF, for example, makes policy decisions using policy rules and forwards session and media related information, obtained from an application function, to the A-RACF for admission control purposes. The A-RACF is a functional element that performs resource reservation admission control and network policy assembly functions. For simplicity of illustration, some intermediate network elements such as access gateways and server nodes are not shown. Further explanation regarding the operation of an IMS network is available in the literature, and is known to those skilled in the art.

At the user level, access terminals 56a, 56b provide a means for users to communicate with one another over the network(s). Each terminal is an electronic device with hardware and/or software-based functionality for communicating over a network, and typically including user input/output means such as a keyboard and display. Examples include computer terminals, as well as wireless units such as mobile phones, wireless PDA's, wireless devices with high-speed data transfer capabilities, such as those compliant with “3-G” or “4-G” standards, “WiFi”-equipped computer terminals, and the like. When one terminal 56a initiates communication with another terminal 56b, the network automatically carries out various signaling procedures, according to its communication protocols, to open a communication channel between the two terminals.

In addition to transferring data for voice communication purposes, e.g., VoIP data packets, IMS networks are increasingly used to transfer large data files from one terminal to another. For example, users may desire to obtain electronic music files, video clips, and even full-length movies over the IMS network 10, in lieu of obtaining these materials from conventional sources such as “brick-and-mortar” stores. For this purpose, with reference to FIG. 2, the IMS network 10 may be configured for file downloading. As indicated, a number of terminals 56a-56e (sometimes referred to as “client terminals”) are connected to the network 10 in a standard manner. A server terminal 58 is also connected to the network 10 in a standard manner. For example, the server terminal 58 may be one of the IMS application servers 20 described above. The server terminal 58 includes a database and/or mass storage 60 such as a hard disk or disk array. The database 60 includes a number of data files 62a-62c. In operation, a client terminal 56a contacts the server terminal 58 over the network 10, in a standard manner, for obtaining a selected data file 62a. For example, the server terminal 58 may be a designated server terminal for file downloads, with the client terminals being informed of the server terminal address by way of an Internet website/index, directory, pre-programmed information, or the like. After one or more optional administrative functions (e.g., requiring the client terminal to provide electronic payment for the file), the requested file 62a is transferred over the network 10 to the client terminal 56a, as indicated by the arrow labeled “A.”

While the traditional server-client configuration shown in FIG. 2 is effective for file downloads in an IMS network at a basic level, there is no way for the service provider to identify file download-related traffic. That is, file download data, even if it occupies substantial bandwidth, is viewed like any other data. Thus, the service provider cannot manage download traffic specifically, and there is no way to bill according to data traffic type. Instead, billing is based on traffic volume only, as with other data. Additionally, the download system/feature is dependent on the server for operation. If the server's resources are overtaxed, file transfer times may suffer, which may require that the server be outfitted with additional storage, processing, and bandwidth resources, or that more than one server terminal be provided for the file download system. Similarly, if the server fails, the entire file download system fails.

### SUMMARY OF THE INVENTION

The present invention relates to a system and method for peer-to-peer file transfer or download in an IMS (IP Multimedia Subsystem) or other network. In the system, data files (or portions thereof) are transferred between peer terminals, instead of from a central server terminal, reducing the possibility of service interruptions due to server failure or overloading. Additionally, the system is accessed through secure accounts that require user authentication for downloading data files, thereby forming a network domain with trusted users who can be required to pay for file transfer/download services. Accounting data relating to file transfer may also be generated through the secure accounts, allowing the system to specifically track peer-to-peer data traffic in the IMS network, e.g., for billing purposes.

In one embodiment, the system includes one or more server applications and a plurality of client/peer terminals, all of which communicate over the IMS network. By “terminal,” it is meant an electronic device capable of communicating over a network. The server application is a network-connected, software- and/or hardware-based module (e.g., a server terminal) configured for carrying out one or more peer-to-peer file transfer management functions of the system. In operation, for downloading a selected data file, a client terminal accesses the server application(s) through a secure account. Upon request from the client terminal, the server application transmits the network location of the data file to the client terminal. By “network location,” it is meant the address or other location of the data file in the IMS network, a peer terminal having the data file stored thereon, or the like. The client terminal then obtains the data file based on the network location, e.g., from a peer terminal.

In another embodiment, for peer-to-peer file transfer, a number of data file portions or sections are distributed among the peer terminals. (Together, the data file portions constitute a complete data file, such as a data file containing multimedia content, e.g., a song or video.) The server application transmits the network locations of the data file portions to the client terminal, for transfer of the data file portions from the peer terminals to the client terminal over the IMS network.

In another embodiment, accounting data is generated by the client terminal and/or the peer terminals and transmitted to the server application. The accounting data relates to the transfer of the data file portions from the peer terminals to the client terminal, and may be used for tracking peer-to-peer file transfer traffic. For example, the accounting data may include the rate at which the data file portions were transferred over the IMS network, and/or the amount of data in the data file portions. The accounting data may be automatically securely generated and transmitted during or subsequent to when the data file portions are obtained. By “automatically,” it is meant without user input or initiation, and by “securely” it is meant without the possibility of user intervention or modification, including possible secure transmission over the IMS network. For this purpose, the client/peer terminals may be provided with a client module (e.g., a software- and/or hardware-based application or program) that coordinates, from the client terminal end, (i) communication with the server application, (ii) peer-to-peer file transfer, and (iii) generating and transmitting the accounting data.

In another embodiment, the accounting data is used by the server application for generating billing data, e.g., based on the data transfer rate and/or data transfer volume. By “billing data,” it is meant information/data relating to monetary or similar charges (e.g., credits or debits) applied against a user or user account. Typically, users who obtain a file or file portion from a peer terminal are charged a fee for the file transfer. The peer terminal that transmits the file may be given a credit for transmitting the file.

In another embodiment, the establishment of a secure account with the server application is required for using the system for peer-to-peer file transfer over the IMS network. By “secure account,” it is meant an account (e.g., grouping of related data organized under an account name or other identifier), the access of which is restricted based on user authentication (e.g., account identifier and password protection) and possibly other security features. After establishing an account, for obtaining a data file the client terminal accesses the account on the server application. Subsequently, the client terminal accesses a database on the server for obtaining an information file from the server. The information file is associated with the data file, and may include information relating to the data file, e.g., information describing the file and/or information relating to where the file (or portions thereof) may be obtained.

In another embodiment, the server applications include a server terminal and a tracker module. The server terminal may be a computer terminal housing the accounts, database, and information files. The tracker module is a network-connected software- and/or hardware-based application or program, acting as an agent of the server terminal, for carrying out certain communication and other functions of the file transfer/download system. For example, the information file may include a network address or other location of the tracker module. The client terminal accesses the tracker module at the provided location, and obtains the location of the data file from the tracker module, or the respective locations of data file portions if the data file is divided into different portions stored on different peer terminals. Typically, the tracker module will have the most up-to-date information regarding the location of each piece/portion of the data file.

### BRIEF DESCRIPTION OF THE DRAWINGS

The present invention will be better understood from reading the following description of non-limiting embodiments, with reference to the attached drawings, wherein below:

FIG. 1 is a schematic view of an IP Multimedia Subsystem (IMS) network;

FIG. 2 is a schematic view of a file transfer/download system according to the prior art;

FIG. 3 is a schematic view of a file download system according to an embodiment of the present invention;

FIG. 4 is a schematic view of an additional embodiment of the file download system;

FIG. 5 is a signaling diagram of an additional embodiment of the file download system; and

FIGS. 6A and 6B are flow charts showing operation of an embodiment of the file download system.

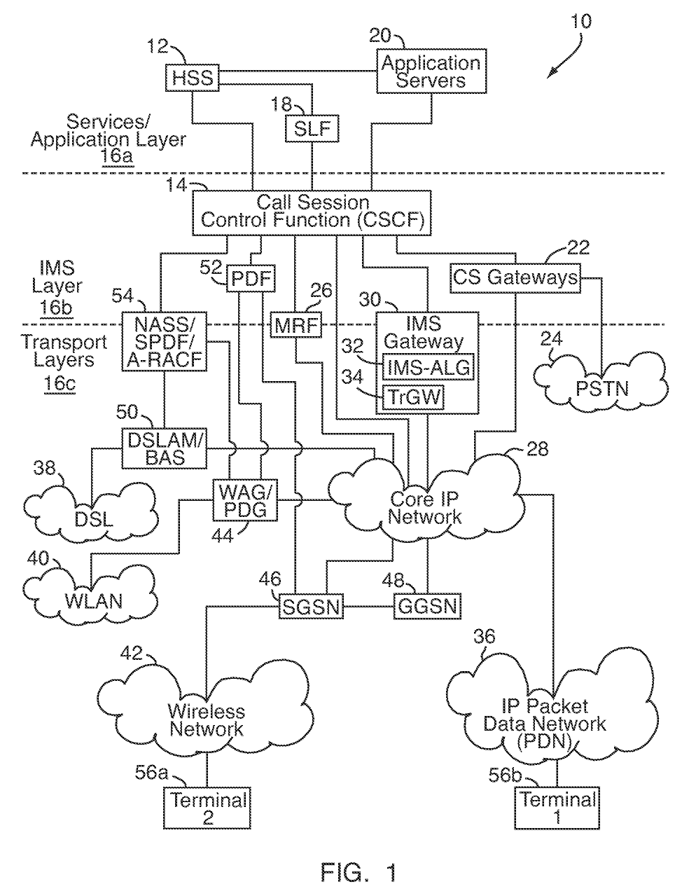

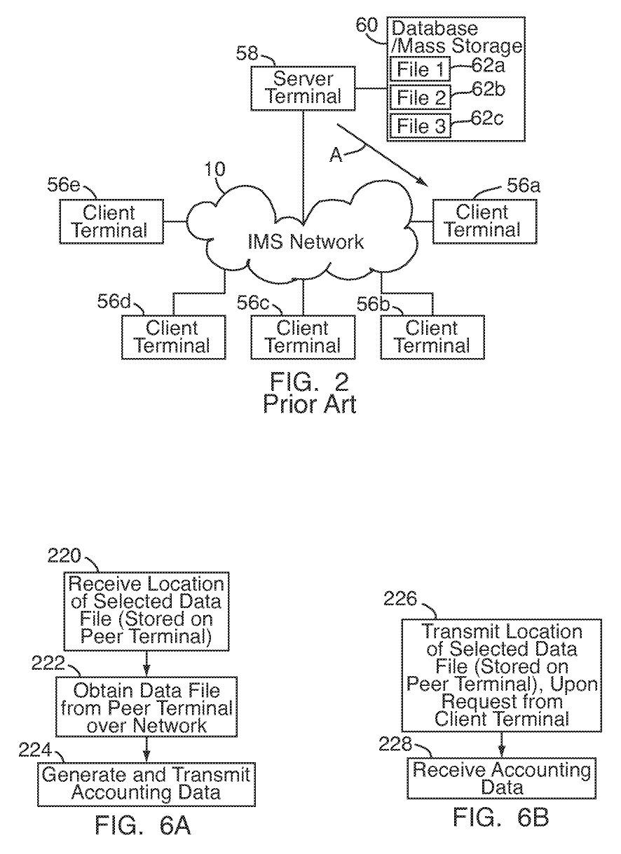

### DETAILED DESCRIPTION

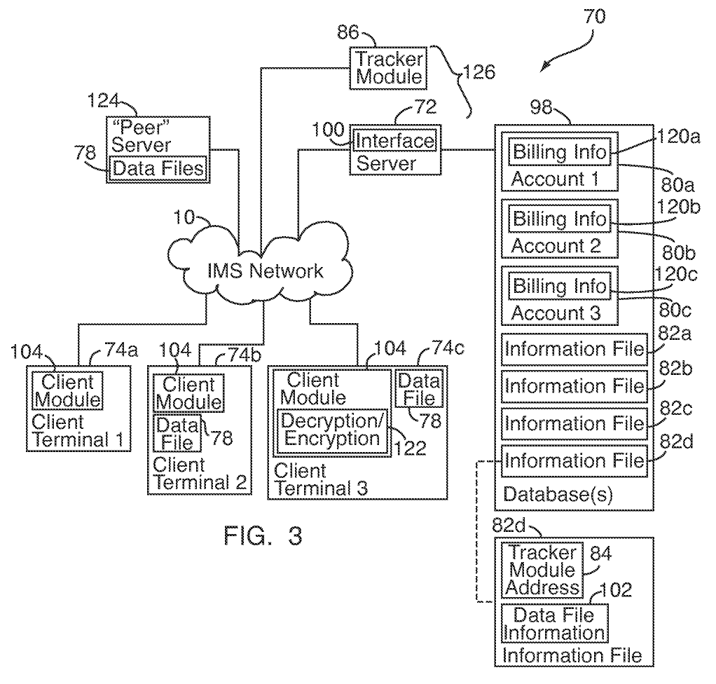

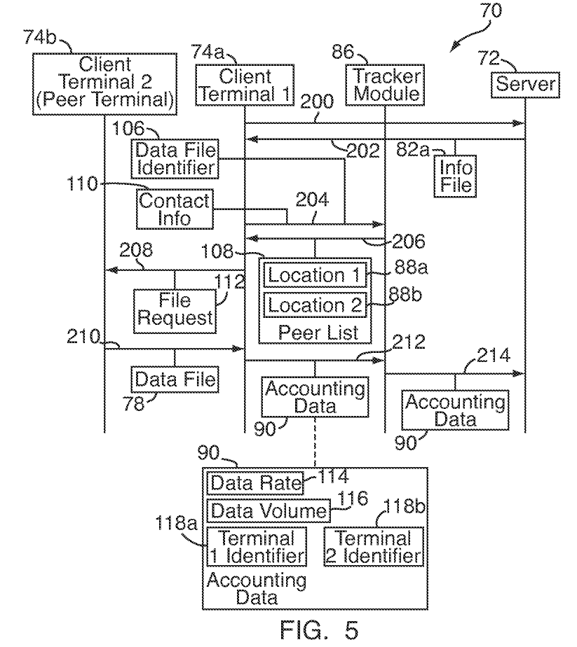

With reference to FIGS. 3-6B, a peer-to-peer file download system 70 includes a server terminal 72 and a number of client or peer terminals 74a-74c interconnected by an IMS (IP Media Subsystem) network 10. For one of the client terminals 74a to obtain a data file 78 over the system 70, the client terminal 74a accesses the server terminal 72 through a pre-established account 80a. Typically, each client terminal 74a-74c will have a secure account 80a-80c on the server, with the establishment of an account being required for using the system 70. The client terminal 74a obtains an information file 82d associated with the data file 78, which is one of a plurality of information files 82a-82d on the server, one for each data file available for download. The information file 82d contains the network address or other location 84 of a tracker module 86. The client terminal 74a accesses the tracker module 86 to obtain the network locations 88a, 88b (see FIG. 5) of one or more of the terminals 74b, 74c that have the data file 78 stored thereon. The client terminal 74a selects and contacts one of these terminals 74b for obtaining the data file 78, that is, after being contacted by the terminal 74a the terminal 74b transmits the data file 78 to the terminal 74a over the IMS network 10. The client terminal 74a securely transmits accounting data 90, relating to the amount of data transferred over the network 10, to the tracker module 86, which forwards it to the server 72 for billing purposes. The accounting data 90 may also contain an indication that the file has been obtained at the client terminal 74a and is available for download from the terminal 74a by other terminals.

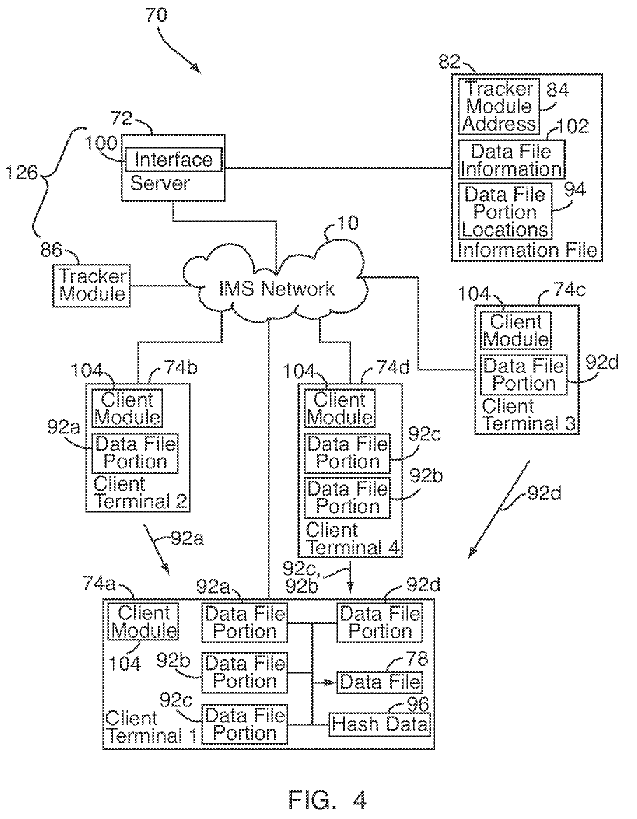

With reference to FIG. 4, the system 70 may be configured in a manner used in certain peer-to-peer networks where data files 78 for downloading are divided into a number of pieces or sections 92a-92d, each about the same size, which are distributed among a number of peer terminals 74b-74d. Here, the client terminal 74a obtains an information file 82 associated with a selected data file 78 from the server terminal 72. (Typically, there will be one information file for each data file available for download over the system.) The information file 82 contains the network address or other location 84 of a tracker module 86. The client terminal 74a accesses the tracker module 86 to obtain the network locations 88a, 88b of the terminals 74b-74d that have the data file sections 92a-92d stored thereon. (Alternatively, the locations may be contained in the information file 82 as a list 94 of data file portion locations.) If more than one terminal has the same data file section, the client terminal 74a chooses among the available choices. Based on the locations, the client terminal 74a obtains the sections 92a-92d of the data file 78 from the terminals 74b-74d, in a peer-to-peer manner. Once all the data file sections/portions are obtained, the data file sections 92a-92d are verified and re-assembled into the data file 78 according to hash information/data 96 made available to the client terminal 74a. The hash data is data used for verifying the data file sections 92a-92d, for reassembling the data file portions 92a-92d into a file 78, and/or for classifying the data file portions 92a-92d for purposes of quick and efficient database storage and retrieval. The hash data 96 may be obtained from the information file 82 associated with the data file 78. One or more of the terminals 74a-74d will also typically transmit accounting data 90, which may also include an indication of which data file sections 92a-92d have finished downloading and are ready to be downloaded by other terminals.

As noted, the system 70 will typically be implemented in conjunction with an IMS network 10, an example of which is described above. The terminals 72, 74a-74d are electronic devices capable of communicating with one another over the network 10, and may include, for example, computer terminals, wire-line connected communication devices such as conventional telephones and enhanced/multimedia-capable telephones, and/or wireless units such as mobile phones, wireless PDA's, wireless devices with high-speed data transfer capabilities, such as those compliant with “3-G” or “4-G” standards, “WiFi”-equipped computer terminals, and the like. The terminals 72, 74a-74d communicate with one another over the network 10 in a standard manner, depending on the particular configuration of the IMS network 10, the particular protocols used for communicating over the network 10, and the types of terminals used for accessing the network. In the case of computer terminals and an IMS network, one terminal (e.g., a client terminal) sends a request for data to another terminal (e.g., a server terminal), and data from the server terminal is transferred back to the client terminal in packet form. For example, for accessing a website on the Internet, a user may enter a URI (uniform resource identifier)/URL (uniform resource locator) or IP address of the website into a web browser software program running on the user's computer terminal, e.g., Microsoft Internet Explorer™. The URL is a string of characters conforming to a standardized format, which refers to a resource on the Internet (such as the home page of the website) by its location, and which may specify the protocol to use to communicate, the host/server to communicate with, the network communication port on the server to connect to, and the path to the resource on the server (for example, its file name). Once the URL is entered, the server terminal is contacted and, if available, the server terminal transmits requested data back to the user's terminal, according to the particular URL. For example, if the URL corresponds to a website home page, data corresponding to the home page (typically in HTML format), as stored on the server, is transmitted back to the user's terminal. The data is translated/decoded by the web browser to recreate the webpage in graphical form on the user terminal's display.

The server terminal 72 is a standard server-configured terminal (or grouping of terminals) having communication means for communicating over the network, e.g., one or more standard network interface cards/modules, modems, or the like. The server terminal 72 also includes mass storage or other memory, which may be organized into one or more databases 98 for storing the accounts 80a-80c and information files 82a-82d. Typically, the server terminal 72 will also include an interface 100 for users to access the server 72 (from the client terminals 74a-74d) to establish accounts, initiate file downloads, and the like. For example, the interface 100 may be an Internet website implemented in a standard manner as well known in the art, e.g., HTML code.

To establish an account 80a on the server for peer-to-peer file transfer, a user at a client terminal 74a accesses the interface 100. For example, if the interface 100 is an Internet website or the like, the user would activate a web browser program on the client terminal 74a and enter a URL of the interface 100 into the web browser. Having accessed the interface 100, the user is provided with options such as “establish new account” and “access existing account.” The user is also provided with information about the system 70, including billing options and rates. If the “establish new account” option is selected, the user is prompted to enter personal information and whatever other information is required for establishing the account, e.g., name, billing address, e-mail address, payment means such as bank account debit or credit card, and security information such as user name and password. This information is stored in a standard manner as one or more associated files in the database 98, as the user's account 80a. To subsequently access the account 80a, the user accesses the interface 100, selects the “access existing account” function (or the like), and enters user authentication information such as account name, password, and/or other security information.

The server terminal 72 also includes the information files 82a-82d stored in the database 98, or otherwise accessible to the server terminal 72. The information files 82a-82d each correspond to a different data file 78 available for download/transfer on the system 70. (In other words, each data file 78 has a corresponding information file 82a-82d stored on the server 72.) Each information file 82a-82d includes the network address or other location 84 of a tracker module 86, e.g., a URL or IP address of the tracker module for accessing the tracker module over the IMS network 10. The tracker module 86, as further described below, may be general purpose in nature, e.g., the tracker module is used in conjunction with more than one data file 78, or it may be individually dedicated or assigned to the data file 78. The information files 82a-82d further include information 102 about their respective associated data files 78, such as file name, file type, file size, subject matter and content summary, and billing information such as rates for obtaining the file, if applicable. For example, in the case of a song or music file, the file information 102 could include the file name, the name of the song, the album with which the song is usually associated, the artist, music genre, file size, file type, e.g., MP3, and the cost for downloading the music file. The information files may also contain hash data 96 relating to the data file 78, or to each data file section 92a-92d if the data file is divided into sections for peer-to-peer transfer.

As an initial step in downloading a data file 78, a user directs the client terminal 74a to access the server terminal 72 through the interface 100, as at Step 200 in FIG. 5, selects the “access existing account” option or the like, and enters the information required for accessing the user's account 80a. Subsequently, the user selects an option for selecting and/or downloading data files. Selecting a data file 78 may involve searching for the data file using key words or the like, searching for categories or groups of files, entering a file name or other identifier, if known, or browsing through a list or selection of available data files, possibly broken down by category, type, or genre. As such, the interface 100 may be provided with functionality for this purpose, such as a standard website search function, various linked web pages for browsing, one or more indices, or the like. Once a particular data file 78 is selected, the user selects a “download” function or the like, and may be asked to approve the billing rate or fee for downloading the file. Then, at Step 202 the information file 82a associated with the selected data file 78 is transferred from the server terminal 72 to the client terminal 74a over the network 10.

The information file 82a is used for purposes of contacting and communicating with the tracker module 86 identified in the information file 82a. For this purpose, the client terminal 74a will typically be provided with a client module 104. The client module 104 is a hardware, hardware/software, or software application/program running on the client terminal 74a and configured to communicate over the network 10 in a standard manner, e.g., the client module 104 accesses the client terminal's network communication means (network interface card, modem, etc.) to send and receive messages and other data over the network 10. The client module 104 may be a utility-like software program operating in the “background” of the client terminal user interface or operating system, and/or it may provide user-accessible functionality such as displaying download status, download history, and the like. It may also function as a client terminal-based interface for accessing the server terminal 72. Typically, the client module 104 will be downloaded from the server 72 when a user first establishes an account. The client module 104 is then installed onto the client terminal in a standard manner. Downloading and installing the client module may be required for using the system 70. Alternatively, the client module may be “built into” a client terminal. For example, in the case of a wireless unit, the client module could be provided as one of the standard available functions on the wireless unit, with the system 70 being operated by the wireless server provider of the wireless unit or a designated third party.

Once the information file 82a is received at the client terminal 74a, at Step 204 the client module 104 initiates communication with the tracker module 86 at the tracker module address/location 84 provided in the information file 82a. In particular, the client module 104 transmits a data file identifier 106 to the tracker module 86 and the tracker module responds with a peer list 108 of which terminals have the data file 78 or data file sections 92a-92d. The data file identifier 106 uniquely identifies the selected data file 78, and will typically be part of the data file information 102 in the information file 82a. For example, the data file identifier may be the file name of the data file, a serial or index number of the data file, or the like. In some systems, the client terminal 74a may also transmit contact information 110 to the tracker module. The client terminal contact information 110 includes whatever information is required for the tracker module 86 to communicate with the client terminal 74a, such as the network address of the client terminal (URL or IP address) and/or the communication port to which the client terminal is listening.

The tracker module 86 is a network-connected software- and/or hardware-based program/application, acting as an agent of the server terminal, for carrying out certain communication and other functions of the system 70. For example, the tracker module 86 may be provided for facilitating peer-to-peer contact for peer-to-peer data file transfer, for collecting accounting data 90 for billing purposes, and/or for tracking which terminals have obtained which data files (or data file sections 92a-92d) over the system. The tracker module 86 implements a simple communication protocol layered on top of HTTP (that is, implemented to operate in conjunction with the communication protocol in place on the network, such as HTTP) in which a client terminal sends the file identifier 106, and the tracker module responds with the peer list 108 containing the network locations/addresses 88a, 88b of client/peer terminals 74b, 74c having the selected data file 78 or, as the case may be, sections 92a-92d of the selected data file 78. The terminals identified in the peer list 108 may have previously downloaded (or be in the process of downloading) the selected data file 78 (or data file section) over the system 70, with the server terminal 72 and/or tracking module 86 having tracked information to that effect for subsequent peer-to-peer downloads initiated by other client terminals. (In other words, when a client terminal downloads a file or file section over the system, the server may be configured to note that the client terminal now has the file or file section available for peer-to-peer download, including storing the client terminal's network address for later providing to client terminals desiring to obtain the data file or file section.) Alternatively, the data file may originate with one of the identified peer terminals 74b, 74c, with that identified peer terminal having notified the server terminal 72 (e.g., from the client module, and/or by accessing the interface 100) that the data file is available for peer-to-peer transfer. In this case, measures may be put in place at the server terminal 72 for safeguarding copyright protected files.

As noted, there may be one tracker module/application 86 used for all peer-to-peer transactions, or, since transaction volume may require more than one tracker module, there may be a plurality of tracker modules 86 that are assigned to transactions as needed. Alternatively, there may be a tracker module 86 associated with each data file 78, with the tracker module being dedicated for transactions involving that data file. In such a case, it would not be necessary for a client terminal to transmit the file identifier 106 to the tracker module. Instead, the data file for downloading would be implied by the client terminal having contacted the particular tracker module. The tracker module(s) 86 may be stored on the server terminal 72 or on another network-connected terminal.

When the tracker module 86 receives the identifier 106 of a selected data file 78 and/or client module contact information 110 from a client terminal 74a, the tracker module 86 responds by sending a peer list 108 to the client terminal 74a, as at Step 206. The peer list 108, as noted, contains a list of the network addresses/locations 88a, 88b of one or more peer terminals having the selected data file 78 or data file sections 92a-92d. These may be all or some subset of the terminals having the selected data file 78 or file sections 92a-92d on the system 70, or only those terminals currently in active communication with the network. Subsequently, the client module 104 (running on the client terminal 74a) selects one of the listed peer terminals if downloading the complete file 78, or one or more of the peer terminals if downloading multiple file sections 92a-92d. The selection may simply be the first active terminal listed in the peer list, or the active peer terminal “closest” to the client terminal 74a on the network 10. Other selection criteria are possible. Peer-to-peer file transfer commences once a peer terminal has been selected, e.g., peer terminal 74b. In particular, at Step 208 the client module 104 initiates communication with the selected peer terminal 74b over the network 10 at the location/address 88a of the peer terminal 74b provided in the peer list 108. For example, this may include transmitting a peer-to-peer file request message 112 to the peer terminal 74b. In response, at Step 210 the client module in place on the selected peer terminal 74b causes the selected data file 78 (or data file section 92a), stored on the peer terminal 74b, to be transmitted to the client terminal 74a in a standard manner. The data file 78 (or data file section 92a) is received at the client terminal 74a and stored for retrieval and subsequent use. If the data file 78 is obtained as a plurality of data file sections 92a-92d, this process is repeated for other peer terminals until all the sections are obtained.

During or subsequent to file or file section transfer, and at least periodically, one or both of the client modules 104 in place on the selected peer terminal 74b and client terminal 74a transfers accounting data 90 to the tracker module 86 (Step 212). The accounting data 90 may include data 114 relating to data transfer rates of the transferred file 78, data 116 relating to the volume of data transferred, and data 118a, 118b identifying the client terminal 74a, peer terminal 74b, and/or the accounts 80a, 80b associated with these terminals. Typically, the transfer rates will be used for statistics purposes, and the data volumes will be used for traffic recording for billing purposes, e.g., billing may be based on the amount of data transferred as opposed to the rate of transfer. Alternatively, users may select a burst transfer rate, which would be billed at a higher rate, or the accounting data may simply indicate that a file has been successfully transferred, if billing is on a per-file basis. Accounting data may be generated and/or used in terms of both upload and download volumes, the latter referring to data received at the requesting client terminal 74a and the former referring to data transferred by the peer terminal 74b. Upload volumes may be used as a basis for billing credits for peer terminals, e.g., peer terminals may, in effect, be paid or credited a small amount for acting as data sources in the system 70, thereby providing an incentive for users of peer terminals to consent to subsequent file transfer to other peer terminals. Typically, the accounting data 90 will be transmitted to the tracker module and/or server terminal in a secure manner such as symmetric encryption, for ensuring that the accounting data is not modified by the user of the client terminal 74a. As should be appreciated, in this manner the generation and transmission of accounting data is performed automatically and without the possibility of user intervention, with use of the client module (and compartmentalized/secure generation of accounting data) being a prerequisite for using the system for peer-to-peer file transfer. Additionally, because each peer user is required to establish a secure account and to use the client module, a secure/trusted peer-to-peer network is established wherein the collection of fees for peer-to-peer data traffic is ensured. In the case of a client terminal 74a obtaining data file sections 92a-92d from multiple terminals 74b-74d, each terminal 74a-74d may generate accounting data 90.

If the accounting data 90 is transmitted to the tracker module 86, the tracker module forwards the data 90 to the server terminal 72, as at Step 214. The server terminal 72 uses the accounting data 90 to generate billing data 120a-120c. By “billing data,” it is meant information/data relating to monetary or similar charges (e.g., credits or debits) applied against a user or user account. Thus, the billing data 120a-120c may be based on the data transfer rates 114 and/or volumes 116, and may include, for example, monetary charges to or against the account(s) identified in, or determinable from, the accounting data 90. For example, if billing rates are based on data volume 116, then an account 80a may be charged a dollar amount as follows:

$charge=(data volume)×($/unit data)

This information is stored as the billing data 120a-120c in the users' respective accounts 80a-80c, with funds being obtained by the system 70 in a standard manner according to the user agreement and account type, e.g., a direct banking account debit, a credit card charge, or the like. Funds collected by the system 70 may be used to pay for copyright licensing fees, and to pay the network service provider for network bandwidth.

As noted, each time a peer terminal obtains a particular data file or data file section, the network address or other location of that terminal is tracked by the tracker module 86 and/or server terminal 72 in association with the data file or data file section. In other words, the tracker module and/or server stores data (e.g., in a database or other storage) associating the address/location of the peer terminal with the data file (or particular pieces/sections of the data file), as an indication that the peer terminal has the data file available for peer-to-peer transfer. When another peer terminal later requests the data file or file section, the database or other storage is searched or otherwise accessed, in relation to the data file, to compile a relevant peer list 108 for the data file. Inclusion in the peer list may depend on whether the terminal is in communication with the network, and as such the tracker module and/or server terminal may perform a test for this condition. Alternatively, a client terminal can select an alternative peer terminal on the peer list if one is found to be unavailable for file transfer.

From the perspective of a client terminal 74a and/or client module 104, for the case of transferring a complete file 78, operation of an embodiment of the system 70 is summarized in FIG. 6A. At Step 220, the client terminal receives the location of a selected data file 78 from the tracker module/application 86 or the server terminal 72. The location may be the network address or other location of the peer terminal 74b on which the data file is stored, or it may be an address or other location of the data file itself, e.g., a sub-address or location on the peer terminal 74b. At Step 222, the client terminal 74a obtains the data file 78 from the peer terminal 74b over the network 10. At Step 224, the client terminal 74a transmits accounting data 90 to the tracker module/application 86 and/or to the server terminal 72. As noted, the accounting data 90 relates to the transfer of the data file from the peer terminal to the client terminal over the network, e.g., data transfer rates and/or data transfer volume. Typically, the accounting data will be automatically securely generated and transmitted during or subsequent to when the data file is obtained. In other words, upon obtaining the data file, the client module automatically (e.g., without user input) and securely (e.g., without the possibility of user intervention) generates the accounting data and automatically and securely transmits it (e.g., secure transmission such as encryption) to the tracker module or server.

For the case of multiple data file sections 92a-92d, the client terminal 74a receives the locations of the sections 92a-92d of a selected data file 78 from the tracker module/application 86 or the server terminal 72. For example, the locations may be the network addresses or other locations of the peer terminals 74b-74d on which the data file sections 92a-92d are stored. The client terminal 74a obtains the data file sections 92a-92d from the peer terminals 74b-74d over the network 10. The terminals 74a-74d transmit accounting data 90 to the tracker module/application 86 and/or to the server terminal 72.

From the perspective of the tracker module 86 or server terminal 72, operation of an embodiment of the system 70 is summarized in FIG. 6B. At Step 226, the server and/or tracker module transmits the network address or other location of a selected data file 78 to a client terminal 74a, upon request from the client terminal 74a. The data file 78 is stored on a peer terminal 74b. Later, at Step 228, the server terminal and/or tracker module receives accounting data 90 from either or both the client terminal 74a and the peer terminal 74b. The accounting data 90 relates to the transfer of the data file from the peer terminal to the client terminal over the network, e.g., data transfer rates and/or data transfer volume. In the case of data file sections 92a-92d, the server and/or tracker module transmits the network addresses or other locations of the data file sections 92a-92d to a client terminal 74a, upon request from the client terminal 74a. The data file sections 92a-92d are stored on peer terminals 74b-74d. Typically, the server terminal and/or tracker module will receive accounting data 90 from all the terminals 74a-74d.

The system 70 may be provided with encryption and/or anti-copying measures whereby the data files 78 or file sections can only be transferred to others through the system 70. For example, the system could be configured such that each time a data file is copied or transferred, the file either automatically self-encrypts or is automatically encrypted by the client module, with the client modules 104 having functionality 122 for decrypting the file for use. Thus, users would be prevented from transferring the data files 78 in a useable form outside the system 70, which might result in copyright infringement, violation of licensing contracts, or the like.

As should be appreciated, the data files 78 may originate with the server terminal 72. For example, music or other data files 78 could be cleared for copyright licensing purposes, and then stored on the server terminal 72. The first time a file (or file section) stored on the server was downloaded, the file or file section would be transferred from the server terminal to the downloading client terminal, in a manner similar to as described above, e.g., the server terminal would function, in effect, like a peer terminal. Alternatively, instead of files being stored on and transferred from the server terminal 72 itself, there could be a dedicated “peer” server 124, configured to function in a manner like a true peer terminal 74b, 74c, for storing and downloading data files 78 in the first instance. The network address or other location of the peer server 124 would be provided in a peer list or the like, as described above. Subsequent to a data file 78 or data file section being downloaded from the server 72 or peer server 124, the server 72 or peer server 124 would be excluded from subsequent peer lists, with the data file 78 instead being transferred peer-to-peer. Alternatively, the server and/or peer server could act as a “backup” in case no peer terminals were available for downloading a particular data file or file section.

Although the tracker modules 86 facilitate an efficient division of communication functions in the system 70, the system 70 could instead be configured for operation solely with the server terminal or terminals 72, without departing from the spirit and scope of the present invention. Thus, the server terminal(s) could be configured for carrying out the functions of the tracker modules described above, with the client/peer terminals communicating directly with the server terminal(s) in all instances except for peer-to-peer file transfer. Additionally, the functions of the tracker module(s) 86 and server terminal 72 could be apportioned differently from the manner described above. Accordingly, the tracker module 86 and server terminal 72 may be collectively or singularly characterized as a “server application” 126, by which it is meant a network-interfaced hardware and/or software unit (or units) configured for carrying out one or more of the server and/or tracker module functions described above.

In the system 70, the IMS network 10 carries out one or more signaling/communication functions for interconnecting the client terminals 74a-74d and server application 126, according to the communication protocols in place on the network 10. Additionally, the system 70 may be configured for the IMS network 10 to carry out one or more of the server application functions described above, e.g., the functions of the tracker module and/or server terminal. For example, the IMS network may be configured (i) to manage client terminal requests for accessing the website interface 100 and downloading a file 78, (ii) to connect client terminals with the server application 126, (iii) to connect client terminals with peer terminals for file transfer, and (iv) to manage the connection between the client terminals and server application 126. In particular, after a file 78 is selected for download at a client terminal 74a through a secure account, the IMS processes the request from the client terminal 74a to download the file, contacts the server application 126, obtains the information file 82d, and transmits it to the client terminal 74a, along with the address 84 of the server application 126 for downloading purposes, e.g., the downloading socket information of the server application 126. The client terminal 74a connects to the server application 126, commences file downloading, and sends a request to the IMS to contact peer terminals 74b-74d having the data file 78 (or portions 92a-92d thereof). The IMS locates the peer terminals 74b-74d, and establishes connections between the client terminal 74a and peer terminals 74b-74d for the client terminal 74a to obtain the data file portions. The IMS may also send messages to the server application 126 for updating purposes.

As should be appreciated, although the data file sections 92a-92d have been characterized as portions or sections of a data file 78, each data file portion is itself a data file, e.g., grouping of data. As such, the data file portions may be characterized as data files, with the data file 78 being a larger, composite data file made up of the plurality of smaller data files or data file sections.

As should be appreciated, the system 70 utilizes a peer-to-peer network model for file download, and an account-based client-server network model for managing file downloads and gathering billing information. Thus, the system is efficient in terms of file transfer while maintaining accuracy, security, and accountability in terms of network bandwidth usage and billing.

Since certain changes may be made in the above-described peer-to-peer file download system for IMS network, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method of transferring data over an IMS network, said method comprising the steps of:
transmitting, to a first client terminal, a network location associated with at least a portion of a data file stored on a second client terminal, for transfer of the data file or portion thereof from the second client terminal to the first client terminal,
wherein the location is transmitted from a server application interfaced with the IMS network for management of peer-to-peer file transfer.

2. The method of claim 1 wherein:
the data file is distributed as a plurality of data file portions among a plurality of second client terminals; and
the method further comprises transmitting network locations associated with said data file portions to the first client terminal, for transfer of the data file portions from the second client terminals to the first client terminal over the IMS network.

3. The method of claim 2 further comprising:
receiving accounting data from the first client terminal and the second client terminals over at least one secure connection, said accounting data relating to the transfer of said data file portions from the second client terminals to the first client terminal.

4. The method of claim 3 further comprising:
generating billing data based on said accounting data, wherein the accounting data includes at least one of a rate at which each of said data file portions was transferred over the IMS network and an amount of data in each of said data file sections.

5. The method of claim 2 further comprising:
transmitting, from a server terminal, a network location of a tracker module to the first client terminal, wherein the tracker module is configured to transmit the network locations of the plurality of data file portions to the first client terminal upon the first client terminal accessing the tracker module at the network location thereof.

6. The method of claim 5 further comprising:
tracking the locations of client terminals which have received data file portions from other client terminals, for providing to client terminals requesting transfer of said data file sections, said locations being tracked by the tracker module.

7. The method of claim 5 further comprising:
transmitting, to the first client terminal, an information file including (i) information relating to said data file and (ii) the network location of said tracker module, for the first client terminal to obtain the network locations of the plurality of data file portions from the tracker module.

8. The method of claim 5 further comprising:
receiving accounting data from the first client terminal and the second client terminals over at least one secure connection, said accounting data relating to the transfer of said data file portions from the second client terminals to the first client terminal; and
generating billing data based on said accounting data, wherein the accounting data includes at least one of a rate at which each of said data file portions was transferred over the IMS network and an amount of data in each of said data file sections.

9. A method of transferring data over an IMS network, said method comprising the steps of:
receiving, at a first client terminal, a network location associated with at least a portion of a data file stored on a second client terminal, said location being received from a server application interfaced with the IMS network; and
obtaining said data file or portion thereof from the second client terminal over the IMS network, based on said location.

10. The method of claim 9 wherein:
the data file is distributed as a plurality of data file portions among a plurality of second client terminals; and
the method further comprises obtaining said data file portions from the second client terminals over the IMS network, based on network locations associated with said data file portions which are received from the server application.

11. The method of claim 10 further comprising:
transmitting accounting data to said server application, wherein the accounting data relates to the transfer of the data file portions from the second client terminals to the first client terminal over the IMS network.

12. The method of claim 11 wherein the accounting data is automatically securely generated and transmitted by said first and second client terminals during or subsequent to transfer of said data file portions from the second client terminals to the first client terminal.

13. The method of claim 12 wherein the accounting data includes at least one of a rate at which each data file portion was obtained over the network and an amount of data transmitted over the network for obtaining each of said data file portions.

14. The method of claim 12 further comprising:
obtaining an information file associated with the data file from a server terminal, said information file including a location of a tracker module having the locations of the data file portions stored thereon; and
accessing the tracker module at the location of the tracker module, to obtain the locations of the data file portions from the tracker module.

15. The method of claim 14 further comprising, prior to obtaining said information file:
accessing a database on said server terminal from a secure account of the first client terminal; and
selecting said information file from among a plurality of information files on said server terminal each relating to a different data file available for transfer over the IMS network.

16. A method of transferring data over a network, said method comprising the steps of:
obtaining, at a first client terminal, a plurality of data file portions from a plurality of second client terminals, said data file portions being obtained based on a plurality of network locations received from a server application,
wherein the first client terminal has a secure account for communicating with said server application, said secure account requiring user authentication for accessing the account to receive said locations from the server application.

17. The method of claim 16 wherein each of said second client terminals has a secure account for communicating with the server application.

18. The method of claim 17 further comprising:
automatically securely generating accounting data relating to the transfer of the data file portions from the second client terminals to the first client terminal over the network; and
transmitting the accounting data to the server application through said secure accounts, said accounting data being generated and transmitted by said first and second client terminals during or subsequent to transfer of said data file portions from the second client terminals to the first client terminal.

19. The method of claim 18 wherein the accounting data includes at least one of a rate at which each data file portion was obtained over the network and an amount of data transmitted over the network for obtaining each of said data file portions.

20. The method of claim 18 further comprising:
obtaining an information file associated with the data file portions from a server terminal, said information file including a location of a tracker module having the locations of the data file portions stored thereon; and
accessing the tracker module at the location of the tracker module, to obtain the locations of the data file portions from the tracker module.
